(19) United States
(12) Patent Application Publication
(10) Pub. No.: US 2026/0343582 A1
(43) Pub. Date: Oct. 29, 2026

(54) TIMING FOR CROSS-LINK INTERFERENCE REPORTING

(71) Applicant: QUALCOMM Incorporated, San Diego, CA (US)

(72) Inventors: Yuwei REN, Beijing (CN); Huilin XU, Temecula, CA (US); Yan ZHOU, San Diego, CA (US); Liangming WU, Beijing (CN); Qian ZHANG, Basking Ridge, NJ (US)

(21) Appl. No.: 19/103,628

(22) PCT Filed: Sep. 23, 2022
(86) PCT No.: PCT/CN2022/120744

§ 371 Date: Feb. 13, 2025

(51) Int. Cl. H04W 72/541; H04B 17/318; H04W 24/10; H04W 72/0446; H04W 72/232

(52) U.S. Cl. CPC H04W 72/541; H04B 17/328; H04W 24/10; H04W 72/0446; H04W 72/232

(57) ABSTRACT

Various aspects of the present disclosure generally relate to wireless communication. In some aspects, a user equipment (UE) may receive downlink control information (DCI) in a physical downlink control channel (PDCCH) communication. The UE may measure cross-link interference (CLI) at a CLI resource indicated by the DCI. The UE may transmit a CLI report in a physical uplink shared channel (PUSCH) communication at a time that is based at least in part on a first minimum processing time between an end of the PDCCH communication and a beginning of the PUSCH communication and a second minimum processing time between an end of the CLI resource and the beginning of the PUSCH communication. Numerous other aspects are described.

### FIELD OF THE DISCLOSURE

Aspects of the present disclosure generally relate to wireless communication and specifically to techniques and apparatuses for reporting cross-link interference.

### BACKGROUND

Wireless communication systems are widely deployed to provide various telecommunication services such as telephony, video, data, messaging, and broadcasts.

Typical wireless communication systems may employ multiple-access technologies capable of supporting communication with multiple users by sharing available system resources (e.g., bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of a user equipment (UE). The method may include receiving downlink control information (DCI) in a physical downlink control channel (PDCCH) communication. The method may include measuring cross-link interference (CLI) at a CLI resource indicated by the DCI. The method may include transmitting a CLI report in a physical uplink shared channel (PUSCH) communication at a time that is based at least in part on a first minimum processing time between an end of the PDCCH communication and a beginning of the PUSCH communication and a second minimum processing time between an end of the CLI resource and the beginning of the PUSCH communication.

Some aspects described herein relate to a method of wireless communication performed by an apparatus of a network entity. The method may include transmitting DCI in a PDCCH communication, the DCI indicating a CLI resource for measuring CLI. The method may include receiving a CLI report in a PUSCH communication after a first minimum processing time from an end of the PDCCH communication and after a second minimum processing time from an end of the CLI resource.

Some aspects described herein relate to an apparatus of a UE for wireless communication. The apparatus may include a memory and one or more processors coupled to the memory. The one or more processors may be configured to receive DCI in a PDCCH communication. The one or more processors may be configured to measure CLI at a CLI resource indicated by the DCI. The one or more processors may be configured to transmit a CLI report in a PUSCH communication at a time that is based at least in part on a first minimum processing time between an end of the PDCCH communication and a beginning of the PUSCH communication and a second minimum processing time between an end of the CLI resource and the beginning of the PUSCH communication.

Some aspects described herein relate to an apparatus of a network entity for wireless communication. The apparatus may include a memory and one or more processors coupled to the memory. The one or more processors may be configured to transmit DCI in a PDCCH communication, the DCI indicating a CLI resource for measuring CLI. The one or more processors may be configured to receive a CLI report in a PUSCH communication after a first minimum processing time from an end of the PDCCH communication and after a second minimum processing time from an end of the CLI resource.

Some aspects described herein relate to a non-transitory computer-readable medium that stores a set of instructions for wireless communication by a UE. The set of instructions, when executed by one or more processors of the UE, may cause the UE to receive DCI in a PDCCH communication. The set of instructions, when executed by one or more processors of the UE, may cause the UE to measure CLI at a CLI resource indicated by the DCI. The set of instructions, when executed by one or more processors of the UE, may cause the UE to transmit a CLI report in a PUSCH communication at a time that is based at least in part on a first minimum processing time between an end of the PDCCH communication and a beginning of the PUSCH communication and a second minimum processing time between an end of the CLI resource and the beginning of the PUSCH communication.

Some aspects described herein relate to a non-transitory computer-readable medium that stores a set of instructions for wireless communication by a network entity. The set of instructions, when executed by one or more processors of the network entity, may cause the network entity to transmit DCI in a PDCCH communication, the DCI indicating a CLI resource for measuring CLI. The set of instructions, when executed by one or more processors of the network entity, may cause the network entity to receive a CLI report in a PUSCH communication after a first minimum processing time from an end of the PDCCH communication and after a second minimum processing time from an end of the CLI resource.

Some aspects described herein relate to an apparatus for wireless communication. The apparatus may include means for receiving DCI in a PDCCH communication. The apparatus may include means for measuring CLI at a CLI resource indicated by the DCI. The apparatus may include means for transmitting a CLI report in a PUSCH communication at a time that is based at least in part on a first minimum processing time between an end of the PDCCH communication and a beginning of the PUSCH communication and a second minimum processing time between an end of the CLI resource and the beginning of the PUSCH communication.

Some aspects described herein relate to an apparatus for wireless communication. The apparatus may include means for transmitting DCI in a PDCCH communication, the DCI indicating a CLI resource for measuring CLI. The apparatus may include means for receiving a CLI report in a PUSCH communication after a first minimum processing time from an end of the PDCCH communication and after a second minimum processing time from an end of the CLI resource.

Aspects generally include a method, apparatus, system, computer program product, non-transitory computer-readable medium, UE, base station, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example base station in communication with a user equipment (UE) in a wireless network in accordance with the present disclosure.

FIG. 3 is a diagram illustrating an example disaggregated base station architecture, in accordance with the present disclosure.

FIGS. 4A-4C are diagrams illustrating examples of full-duplex communication in accordance with the present disclosure.

FIG. 5 is a diagram illustrating an example of full-duplex communication modes, in accordance with the present disclosure.

FIG. 6 is a diagram illustrating examples of report timings, in accordance with the present disclosure.

FIG. 7 is a diagram illustrating an example of cross-link interference (CLI) reporting, in accordance with the present disclosure.

FIG. 8 is a diagram illustrating examples of different timelines for CLI reporting, in accordance with the present disclosure.

FIG. 9 is a diagram illustrating an example process performed, for example, by a UE, in accordance with the present disclosure.

FIG. 10 is a diagram illustrating an example process performed, for example, by a network entity, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

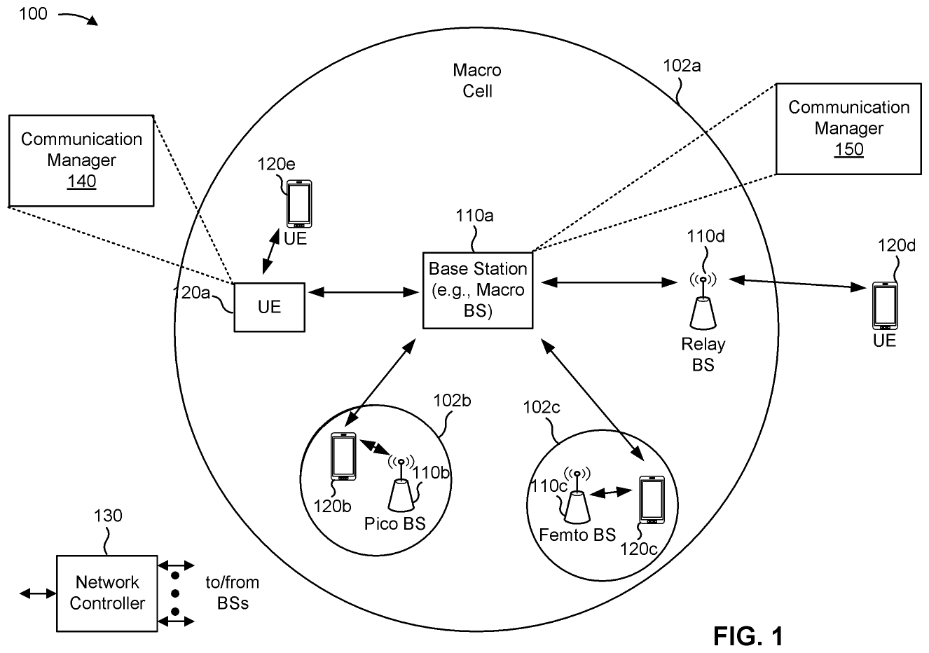

FIG. 1 is a diagram illustrating an example of a wireless network in accordance with the present disclosure. The wireless network 100 may be or may include elements of a 5G (e.g., NR) network or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, or a transmission reception point (TRP). Each base station 110 may provide communication coverage for a particular geographic area. In the Third Generation Partnership Project (3GPP), the term “cell” can refer to a coverage area of a base station 110 or a base station subsystem serving this coverage area, depending on the context in which the term is used.

A base station 110 may provide communication coverage for a macro cell, a pico cell, a femto cell, or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station.

The wireless network 100 may be a heterogeneous network that includes base stations 110 of different types, such as macro base stations, pico base stations, femto base stations, or relay base stations. These different types of base stations 110 may have different transmit power levels, different coverage areas, or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts). In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells. A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

In some aspects, the terms “base station” (e.g., the base station 110) or “network entity” may refer to an aggregated base station, a disaggregated base station, an integrated access and backhaul (IAB) node, a relay node, or one or more components thereof. For example, in some aspects, “base station” or “network entity” may refer to a central unit (CU), a distributed unit (DU), a radio unit (RU), a Near-Real Time (Near-RT) RAN Intelligent Controller (RIC), or a Non-Real Time (Non-RT) RIC, or a combination thereof. In some aspects, the terms “base station” or “network entity” may refer to one device configured to perform one or more functions, such as those described herein in connection with the base station 110. In some aspects, the terms “base station” or “network entity” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network entity” may refer to any one or more of those different devices. In some aspects, the terms “base station” or “network entity” may refer to one or more virtual base stations or one or more virtual base station functions. For example, in some aspects, two or more base station functions may be instantiated on a single device. In some aspects, the terms “base station” or “network entity” may refer to one of the base station functions and not another. In this way, a single device may include more than one base station.

In some examples, a cell may not necessarily be stationary, and the geographic area of the cell may move in accordance with the location of a base station 110 that is mobile (e.g., a mobile base station). In some examples, the base stations 110 may be interconnected to one another or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, or a satellite radio), a vehicular component or sensor, a smart meter/sensor, industrial manufacturing equipment, a global positioning system device, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a base station, another device (e.g., a remote device), or some other entity. Some UEs 120 may be considered Internet-of-Things (IOT) devices, or may be implemented as NB-IOT (narrowband IoT) devices.

Some UEs 120 may be considered a Customer Premises Equipment. A UE 120 may be included inside a housing that houses components of the UE 120, such as processor components or memory components. In some examples, the processor components and the memory components may be coupled together. For example, the processor components (e.g., one or more processors) and the memory components (e.g., a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the base station 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHz). It should be understood that although a portion of FR1 is greater than 6 GHz, FR1 is often referred to (interchangeably) as a “Sub-6 GHZ” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHZ), FR4 (52.6 GHZ-114.25 GHZ), and FR5 (114.25 GHz-300 GHz). Each of these higher frequency bands falls within the EHF band.

With the above examples in mind, unless specifically stated otherwise, it should be understood that the term “sub-6 GHZ,” if used herein, may broadly represent frequencies that may be less than 6 GHz, may be within FR1, or may include mid-band frequencies. Further, unless specifically stated otherwise, it should be understood that the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (e.g., FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive downlink control information (DCI) in a physical downlink control channel (PDCCH) communication; and measure cross-link interference (CLI) at a CLI resource indicated by the DCI. The communication manager 140 may transmit a CLI report in a physical uplink shared channel (PUSCH) communication at a time that is based at least in part on a first minimum processing time between an end of the PDCCH communication and a beginning of the PUSCH communication and a second minimum processing time between an end of the CLI resource and the beginning of the PUSCH communication. Additionally, or alternatively, the communication manager 140 may perform one or more other operations described herein.

In some aspects, a network entity (e.g., base station 110) may include a communication manager 150. As described in more detail elsewhere herein, the communication manager 150 may transmit DCI in a PDCCH communication, the DCI indicating a CLI resource for measuring CLI. The communication manager 150 may receive a CLI report in a PUSCH communication after a first minimum processing time from an end of the PDCCH communication and after a second minimum processing time from an end of the CLI resource. Additionally, or alternatively, the communication manager 150 may perform one or more other operations described herein.

As indicated above, FIG. 1 is provided as an example. Other examples may differ from what is described with regard to FIG. 1.

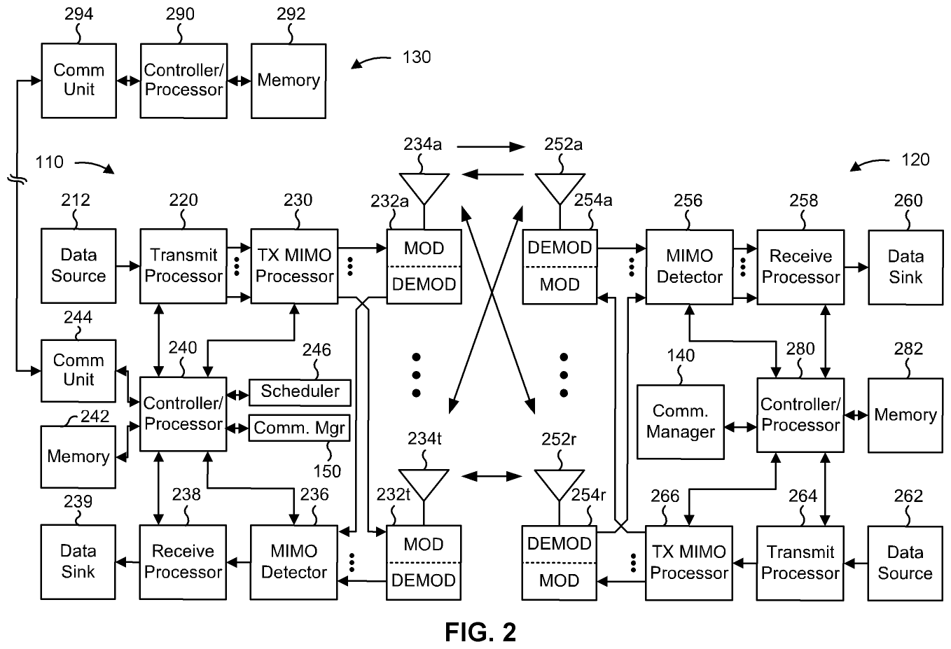

FIG. 2 is a diagram illustrating an example base station 110 in communication with a UE 120 in a wireless network in accordance with the present disclosure. The base station 110 may correspond to the base station 110 of FIG. 1. Similarly, the UE 120 may correspond to the UE 120 of FIG. 1. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (e.g., for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (e.g., the controller/processor 280) and the memory 282 to perform aspects of any of the methods described herein.

At the base station 110, the uplink signals from UE 120 or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (e.g., the controller/processor 240) and the memory 242 to perform aspects of any of the methods described herein.

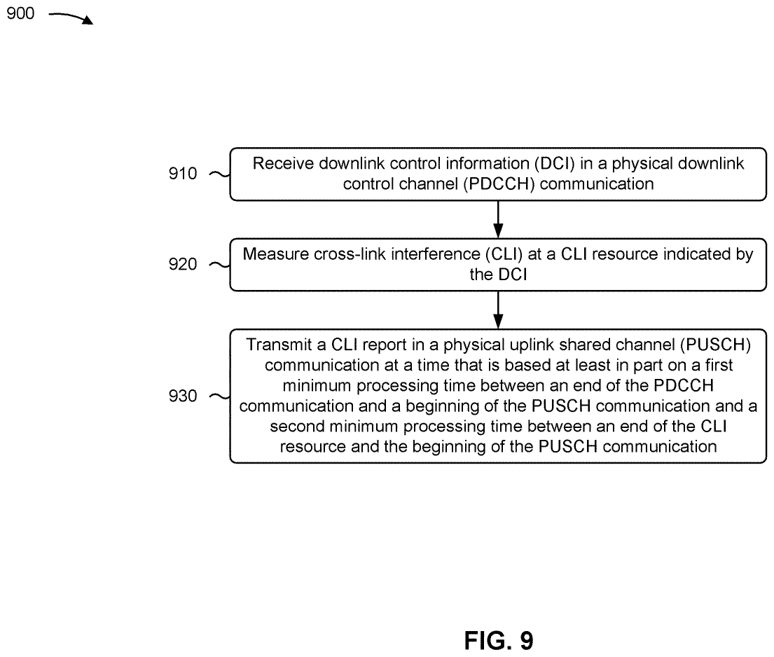

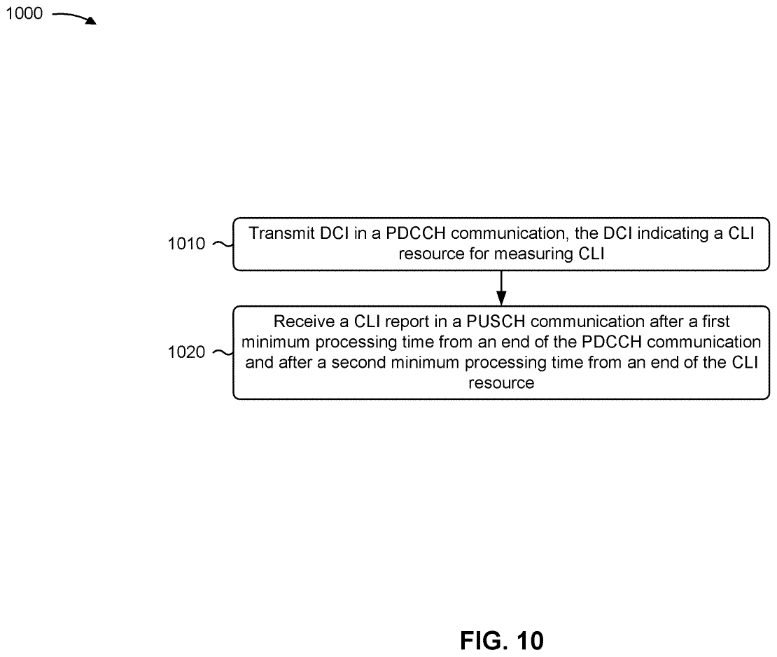

The controller/processor of a network entity (e.g., controller/processor 240 of the base station 110), the controller/processor 280 of the UE 120, or any other component(s) of FIG. 2 may perform one or more techniques associated with reporting CLI, as described in more detail elsewhere herein. For example, the controller/processor 240 of the base station 110, the controller/processor 280 of the UE 120, or any other component(s) of FIG. 2 may perform or direct operations of, for example, process 900 of FIG. 9, process 1000 of FIG. 10, or other processes as described herein. The memory 242 and the memory 282 may store data and program codes for the base station 110 and the UE 120, respectively. In some examples, the memory 242 or the memory 282 may include a non-transitory computer-readable medium storing one or more instructions (e.g., code or program code) for wireless communication. For example, the one or more instructions, when executed (e.g., directly, or after compiling, converting, or interpreting) by one or more processors of the base station 110 or the UE 120, may cause the one or more processors, the UE 120, or the base station 110 to perform or direct operations of, for example, process 900 of FIG. 9, process 1000 of FIG. 10, or other processes as described herein. In some examples, executing instructions may include running the instructions, converting the instructions, compiling the instructions, or interpreting the instructions, among other examples.

In some aspects, the UE 120 includes means for receiving DCI in a PDCCH communication; means for measuring CLI at a CLI resource indicated by the DCI; and/or means for transmitting a CLI report in a PUSCH communication at a time that is based at least in part on a first minimum processing time between an end of the PDCCH communication and a beginning of the PUSCH communication and a second minimum processing time between an end of the CLI resource and the beginning of the PUSCH communication. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., base station 110) includes means for transmitting DCI in a PDCCH communication, the DCI indicating a CLI resource for measuring CLI; and/or means for receiving a CLI report in a PUSCH communication after a first minimum processing time from an end of the PDCCH communication and after a second minimum processing time from an end of the CLI resource. In some aspects, the means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station.

An aggregated base station may be configured to utilize a radio protocol stack that is physically or logically integrated within a single RAN node (e.g., within a single device or unit). A disaggregated base station may be configured to utilize a protocol stack that is physically or logically distributed among two or more units (such as a CU, one or more DUs, or one or more RUs). In some examples, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

As indicated above, FIG. 2 is provided as an example. Other examples may differ from what is described with regard to FIG. 2.

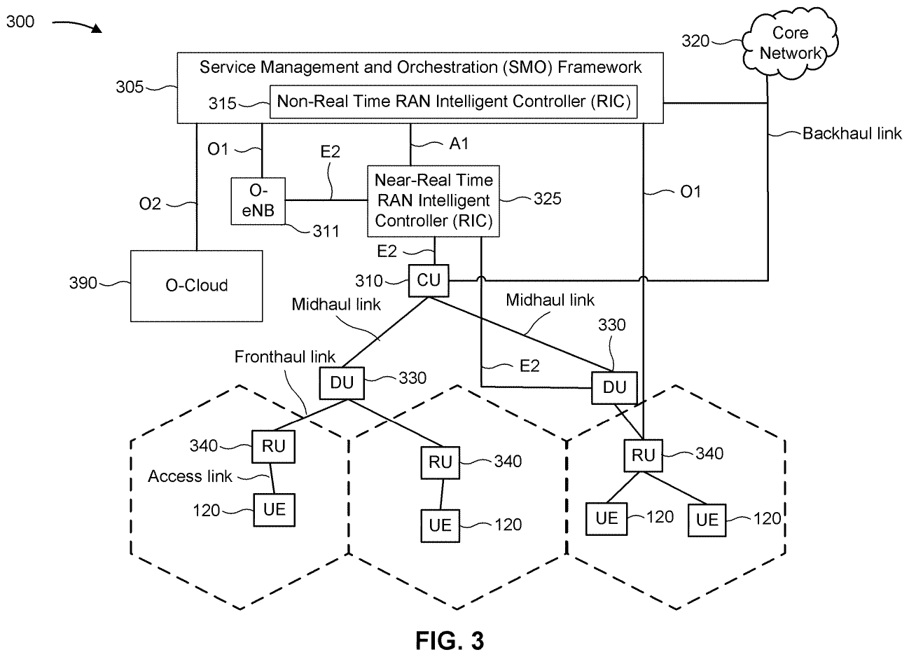

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (e.g., Central Unit-User Plane (CU-UP) functionality), control plane functionality (e.g., Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which may also be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based at least in part on a functional split (e.g., a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an Ol interface) or via creation of RAN management policies (such as Al interface policies).

As indicated above, FIG. 3 is provided as an example. Other examples may differ from what is described with regard to FIG. 3.

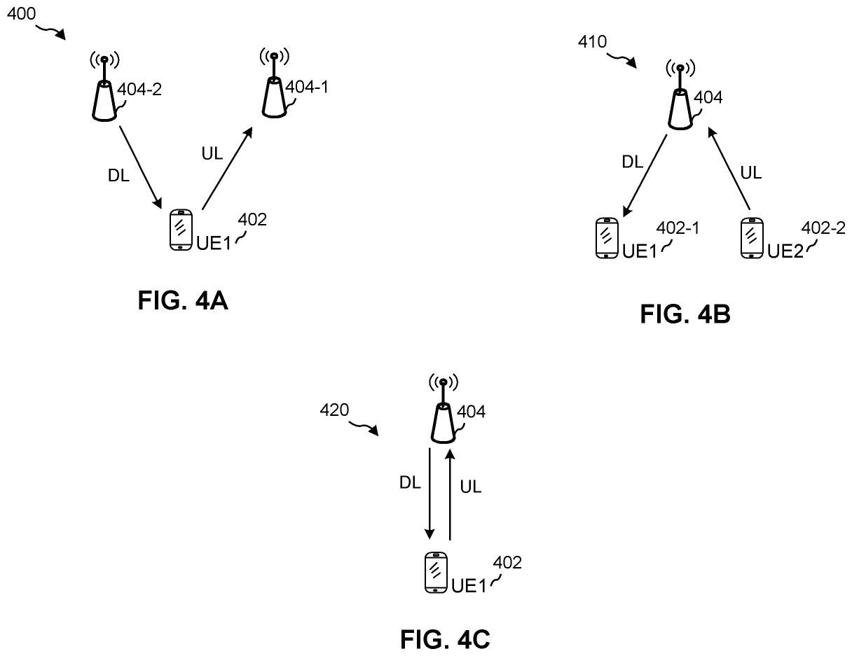

FIGS. 4A-4C are diagrams illustrating examples of full-duplex (FD) communication in accordance with the present disclosure. A first full-duplex scenario 400 depicted in FIG. 4A includes a UE1 402 and two base stations (e.g., network entities or TRPs) 404-1, 404-2, where the UE1 402 is sending uplink transmissions to base station 404-1 and is receiving downlink transmissions from base station 404-2. In the first full-duplex scenario 400 of FIG. 4A, FD is enabled for the UE1 402, but not for the base stations 404-1, 404-2. A second full-duplex scenario 410 depicted in FIG. 4B includes two UEs, shown as UE1 402-1 and UE2 402-2, and a base station 404, where the UE1 402-1 is receiving a downlink transmission from the base station 404 and the UE2 402-2 is transmitting an uplink transmission to the base station 404. In the second full-duplex scenario 410, FD is enabled for the base station 404, but not for UE1 402-1 and UE2 402-2. A third full-duplex scenario 420 is depicted in FIG. 4C that includes a UE1 402 and a base station 404, where the UE1 402 is receiving a downlink transmission from the base station 404 and the UE1 402 is transmitting an uplink transmission to the base station 404. In the third full-duplex scenario 420, FD is enabled for both the UE1 402 and the base station 404.

As indicated above, FIGS. 4A-4C provide some examples. Other examples may differ from what is described with regard to FIGS. 4A-4C.

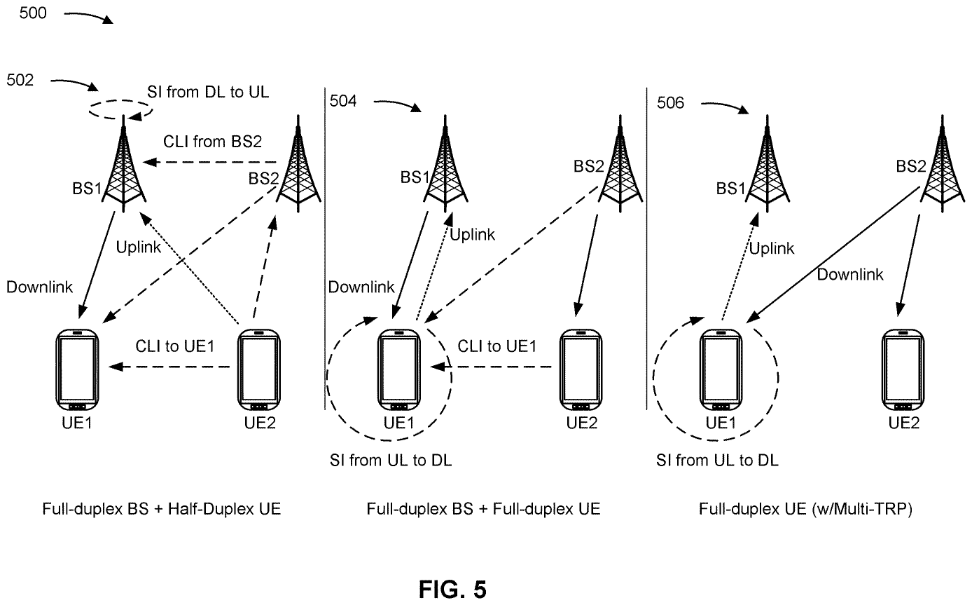

FIG. 5 is a diagram illustrating an example of full-duplex communication modes 500, in accordance with the present disclosure. In a first mode 502, a first network entity (shown as BS1) and a second network entity (shown as BS2) may be full-duplex devices (e.g., may be capable of communicating in a full-duplex manner). A first UE (shown as UE1) and a second UE (shown as UE2) may be half duplex UEs (e.g., may not be capable of communicating in a full-duplex manner). The first network entity may perform downlink transmissions to the first UE, and the first network entity may receive uplink transmissions from the second UE. The first network entity may experience system information (SI) from a downlink to an uplink based at least in part on the downlink transmissions to the first UE and the uplink transmissions received from the second UE. The first network entity may experience CLI from the second network entity. CLI may also occur when a network entity configures different time division duplex (TDD) uplink and downlink slots to nearby UEs. For example, the first UE may experience CLI from the second network entity and the second UE. If the first UE's downlink symbol collides with at least one uplink symbol of the second UEs, the first UE may be considered a “victim UE” and the second UE may be considered an “aggressor UE”.

In a second mode 504, a first network entity and a second network entity may be full-duplex devices. A first UE and a second UE may be full-duplex UEs. The first network entity may perform downlink transmissions to the first UE, and the first network entity may receive uplink transmissions from the first UE. The first UE may experience SI from an uplink to a downlink based at least in part on the downlink transmissions from the first network entity and the uplink transmissions to the first network entity. The first UE may experience CLI from the second network entity and the second UE. CLI may occur between two UEs on the same cell or on different cells.

In a third mode 506, a first UE and a second UE may be full-duplex UEs and may communicate in a multiple TRP (multi-TRP) configuration. A first network entity may receive uplink transmissions from the first UE, and a second network entity may perform downlink transmissions to the first UE and the second UE. The first UE may experience SI from an uplink to a downlink based at least in part on the uplink transmissions to the first network entity and the downlink transmissions from the second network entity.

A victim UE may measure CLI from an aggressor UE. The aggressor UE may not transmit anything dedicated for CLI measurement by a victim UE and does not know if an uplink transmission is measured by a victim UE. The victim UE may measure CLI if the network entity configures one or more CLI measurement resources for CLI measurement.

CLI measurements may be defined as periodic Layer 3 (L3) measurements based on, for example, a sounding reference signal (SRS) RSRP or an RSSI. The victim UE may use a receive timing to receive the CLI that is different than the receive timing of a serving cell signal or channel. The victim UE may also expect to use a dedicated FFT window timing to receive the CLI. For example, when the victim UE measures SRS-RSRP or CLI-RSSI, the victim UE may apply a constant offset value relative to the downlink reference timing in the serving cell. For inter-cell CLI, the constant offset value may account for the uplink/downlink timing difference of the aggressor UE, a cell size difference between the aggressor UE's serving cell and the victim UE's serving cell, and the delay between the two UEs. For intra-cell CLI, the constant offset value may account for the uplink/downlink timing difference of the aggressor UE and the delay between the two UEs. Because CLI emerges when the two UEs are close to each other, the constant offset value may be approximate to the victim UE's uplink timing advance. For 3GPP Release 18 interference management with dynamic flexible duplexing, Layer 1 (L1) CLI measurement reports may be defined to facilitate a more dynamic TDD uplink/downlink slot format configuration.

As indicated above, FIG. 5 is provided as an example. Other examples may differ from what is described with regard to FIG. 5.

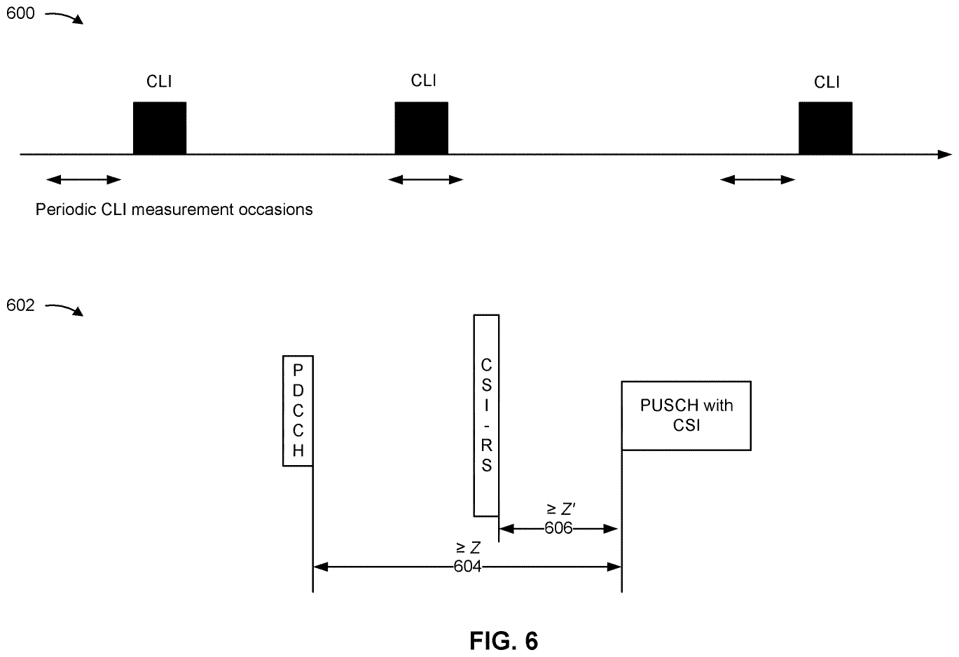

FIG. 6 is a diagram illustrating examples 600 and 602 of report timings, in accordance with the present disclosure.

CLI reporting may be periodic or use semi-persistent scheduling (SPS). Example 600 shows an example of periodic CLI measurement resources. However, as shown by example 600, periodic CLI measurement resources may miss some CLI. This may result in inaccurate CLI measurements, a waste of power, and a waste of processing resources. In some aspects, L1 aperiodic CLI measurement reports may be useful for measuring interference caused by dynamic TDD and full duplex. A network entity may transmit a PDCCH communication (e.g., DCI) to trigger a CLI report.

There may be a timeline defined for the CLI reporting of CLI measurements. In some aspects, the timeline for CLI reporting may be similar to a timeline for channel state information (CSI) reporting. For CSI reporting, if CSI is measured for a CSI reference signal (CSI-RS), the time interval 604 from the end of the PDCCH communication that triggers the CSI report to the start of the PUSCH communication that carries the CSI report is expected be no less than Z. The time interval 606 from the end of the CSI-RS that is used for the CSI report to the start of the PUSCH that carries the CSI report is expected to be no less than Z′. Z is or accounts for the minimum total processing time for PDCCH decoding, CSI-RS processing, and the preparation time of the PUSCH communication that carries the CSI. Z′ is or accounts for the minimum total processing time for CSI-RS processing and the preparation time of the PUSCH communication. Both Z and Z′ may be defined in OFDM symbols based on the minimum of a subcarrier spacing (SCS) of the PDCCH, the CSI-RS, and the PUSCH.

As indicated above, FIG. 6 is provided as an example. Other examples may differ from what is described with regard to FIG. 6.

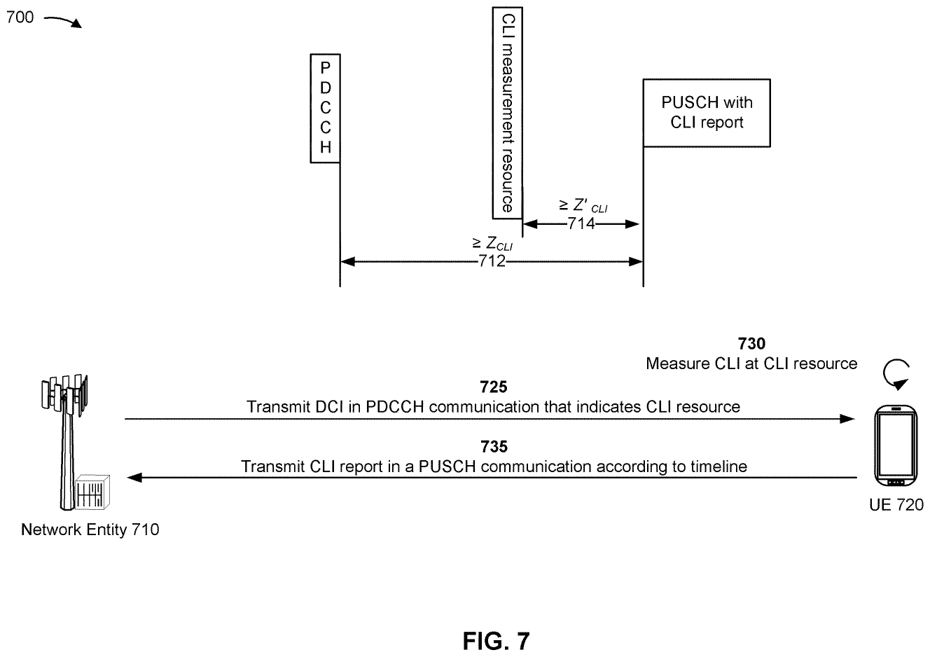

FIG. 7 is a diagram illustrating an example 700 of CLI reporting, in accordance with the present disclosure. A network entity 710 (e.g., base station 110) and a UE 720 (e.g., UE 120) may communicate with each other via a wireless network (e.g., wireless network 100).

According to various aspects described herein, the UE 720 may use aperiodic CLI reporting that accounts for processing times of a CLI report. The UE 720 may use a CLI reporting timeline that accounts for a minimum processing time for the PDCCH communication triggering the aperiodic CLI report, the processing of the CLI measurement, and a preparation time of the PUSCH communication that carriers the CLI report. For L1 aperiodic CLI measurement reports, a time interval 712 between the end of the PDCCH communication and the start of the PUSCH communication may be equal to or greater than the minimum processing time Z_{CLI} for decoding the PDCCH triggering the CLI measurement. A time interval 714 may be equal to or greater than the minimum processing time Z′_{CLI} for processing the CLI measurement resource and preparing the PUSCH carrying the CLI measurement report. In this way, the UE 720 does not waste processing resources on missed CLI and or on generating a CLI report that may not be transmitted due to an insufficient amount of processing time.

As shown by reference number 725, the network entity 710 may transmit DCI in a PDCCH communication. The DCI may indicate a CLI resource. As shown by reference number 730, the UE 720 may measure CLI at the CLI resource. As shown by reference number 735, the UE 720 may transmit a CLI report in a PUSCH communication according to a timeline. The timeline may include transmitting the CLI report in the PUSCH communication at a time that is based at least in part on a first minimum processing time (e.g., Z_{CLI}) between an end of the PDCCH communication and a beginning of the PUSCH communication and a second minimum processing time (e.g., Z′_{CLI}) between an end of the CLI resource and the beginning of the PUSCH communication. The time may be no earlier than time interval 712 after the end of the PDCCH communication and no earlier than time interval 714 after an end of the CLI measurement resource. The network entity 710 may transmit an indication of the first minimum processing time and the second minimum processing time on which the time interval 712 and the time interval 714 are based. The time interval 712 and the time interval 714 may be defined in symbols.

In some aspects, the length of the first minimum processing time and/or the length of the second minimum processing time are based at least in part on a minimum SCS of an SCS of the PDCCH, an SCS of the CLI resource, and an SCS of the PUSCH. In some aspects, the length of the first minimum processing time is based at least in part on a UE capability for reporting CLI and a third minimum processing time (e.g., Z) between the end of the PDCCH communication and a time for transmitting a CSI report. The UE 720 may transmit an indication of the UE capability for reporting CLI. The UE capability may include information about a processing capability of the UE 720 or explicit minimum processing times.

In some aspects, due to the similarity between aperiodic CSI and an aperiodic L1 CLI report, the UE 720 may derive the timeline for the CLI report (including time interval 712≥Z_{CLI} and time interval 714≥Z′_{CLI}) based at least in part on a minimum processing time Z and/or a minimum processing time Z′ for CSI reporting.

The UE 720 may switch from one FFT window timing for a downlink serving cell signal or for channel reception for PDCCH to another FFT window timing for the reception of a CLI measurement resource. This may involve extra operating time for the UE 720 and thus the time interval 712 between the PDCCH communication and the CLI measurement resource may be extended. For example, the UE 720 may include adding time (e.g., a configured time addition n) for reporting CLI to a minimum processing time Z for transmitting a CSI report, such that Z_{CLI}=Z+n, where n≥1. The time addition n may be based at least in part on a UE capability for processing CLI. The time addition n may be specified in stored configuration information or indicated by the network entity 710. The time addition n may account for a receive timing difference between receiving CLI at the CLI measurement resource and receiving a serving cell downlink signal. The time addition n may be based at least in part on a time for switching between a receive FFT window timing for the CLI resource and a receive FFT window for a CSI reference signal.

In some aspects, the time addition n may be a first value for intra-cell CLI management and a second value for inter-cell CLI management. The inter-cell timing difference may be related to the cell size. The intra-cell timing difference may be roughly 2 times the timing advance (TA). The CLI measurement may be with an uplink TA, and downlink signal reception may be with a downlink TA. For example, an aggressor UE may be at the cell edge. An uplink TA1 of a first UE in a first cell may be different than an uplink TA2 of a second UE in a second cell. The first cell may be larger than the second cell and thus TA1 may be larger than TA2. That is, TA1 and TA2 may be proportional to cell size.

In some aspects, the UE 720 may add time (configured time addition n′) for reporting CLI to a minimum processing time Z′_{CLI} for transmitting a CSI report, such that Z′_{CLI}=Z′+n, where n≥1. The time addition n′ may be based at least in part on a UE capability. The time addition n′ may be specified in stored configuration information or indicated by the network entity 710. The time addition n′ may account for a receive timing difference between receiving CLI at the CLI measurement resource and receiving a serving cell downlink signal. The time addition n′ may be a first value for intra-cell CLI management and a second value for inter-cell CLI management.

As indicated above, FIG. 7 is provided as an example. Other examples may differ from what is described with regard to FIG. 7.

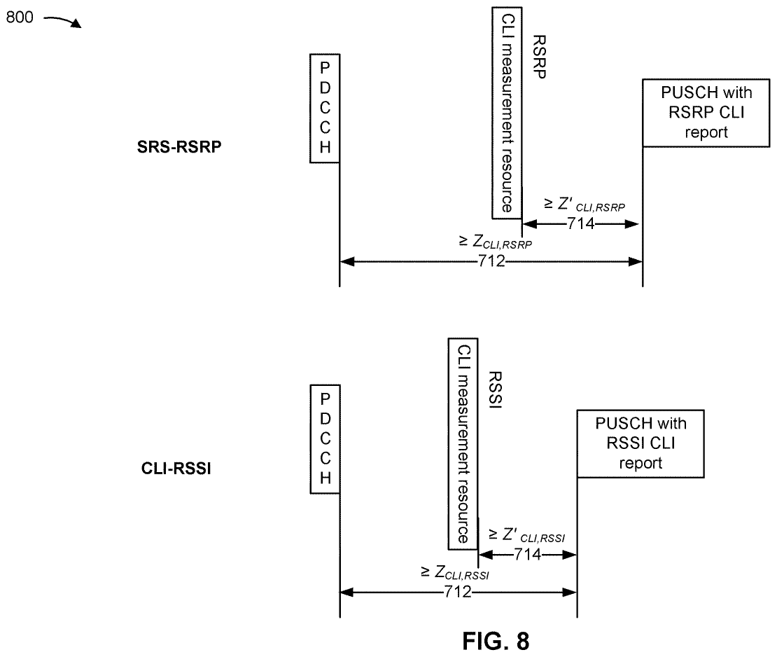

FIG. 8 is a diagram illustrating example of different timelines for CLI reporting, in accordance with the present disclosure.

CLI management may involve two separate resources for interference measurement and reporting. Example 800 shows that one resource may be for SRS-RSRP and another resource for CLI-RSSI. These two metrics have different processing times and thus time intervals 712 and 714 may have different lengths based at least in part on whether the resource is for SRS-RSRP or CLI-RSSI. For example, the first minimum processing time Z_{CLI} may include a first minimum processing time Z_{CLI, RSRP} specific to an SRS-RSRP or a first minimum processing time Z_{CLI, RSSI} specific to a CLI-RSSI. RSRP measurements may take longer than the timeline of the RSSI. Furthermore, the quantity of the RSRP resources may be less than the quantity of the RSSI resources. Therefore, as shown by example 800, the length of Z_{CLI, RSRP} may be greater than the length of Z_{CLI, RSSI}. The second minimum processing time Z′_{CLI} may include a second minimum processing time Z′_{CLI, RSRP} specific to the SRS-RSRP or a second minimum processing time Z′_{CLI, RSSI} specific to the CLI-RSSI. The length of Z′_{CLI, RSRP} may be greater than the length of Z′_{CLI, RSSI}.

Alternatively, CLI management may use a unified timeline. For example, the first minimum processing time Z_{CLI} may applicable to both an SRS-RSRP and a CLI-RSSI. The second minimum processing time Z′_{CLI} may be applicable to both the SRS-RSRP and the CLI-RSSI.

By using minimum processing times for aperiodic CLI reporting, the UE 720 may more reliably provide CLI reports. As a result, the network entity may better schedule an NES mode or communications and control transmit powers to reduce interference and improve communications.

As indicated above, FIG. 8 is provided as an example. Other examples may differ from what is described with regard to FIG. 8.

FIG. 9 is a diagram illustrating an example process 900 performed, for example, by a UE, in accordance with the present disclosure. Example process 900 is an example where the UE (e.g., UE 120, UE 720) performs operations associated with timing for CLI reporting.

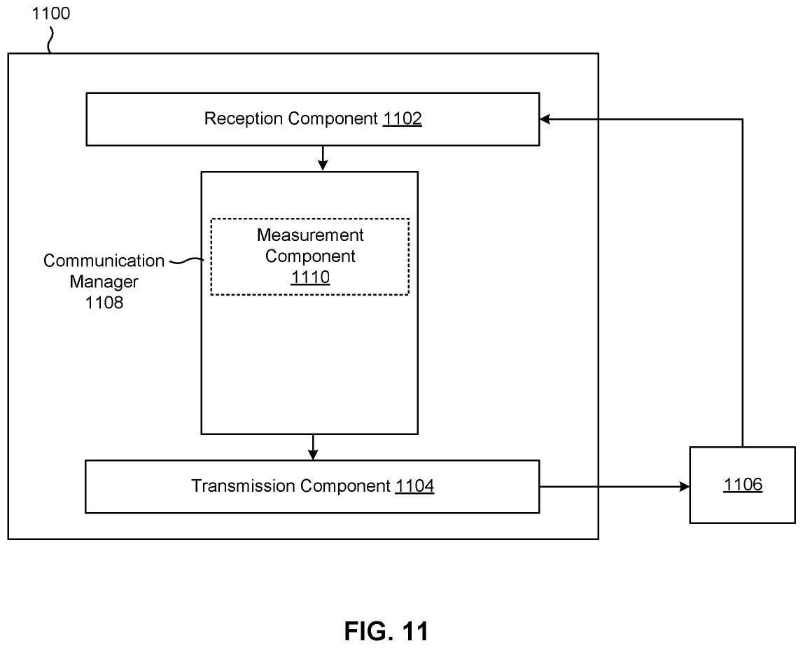

As shown in FIG. 9, in some aspects, process 900 may include receiving DCI in a PDCCH communication (block 910). For example, the UE (e.g., using communication manager 1108 and/or reception component 1102 depicted in FIG. 11) may receive DCI in a PDCCH communication, as described above.

As further shown in FIG. 9, in some aspects, process 900 may include measuring CLI at a CLI resource indicated by the DCI (block 920). For example, the UE (e.g., using communication manager 1108 and/or measurement component 1110 depicted in FIG. 11) may measure CLI at a CLI resource indicated by the DCI, as described above.

As further shown in FIG. 9, in some aspects, process 900 may include transmitting a CLI report in a PUSCH communication at a time that is based at least in part on a first minimum processing time between an end of the PDCCH communication and a beginning of the PUSCH communication and a second minimum processing time between an end of the CLI resource and the beginning of the PUSCH communication (block 930). For example, the UE (e.g., using communication manager 1108 and/or transmission component 1104 depicted in FIG. 11) may transmit a CLI report in a PUSCH communication at a time that is based at least in part on a first minimum processing time between an end of the PDCCH communication and a beginning of the PUSCH communication and a second minimum processing time between an end of the CLI resource and the beginning of the PUSCH communication, as described above.

Process 900 may include additional aspects, such as any single aspect or any combination of aspects described below and/or in connection with one or more other processes described elsewhere herein.

In a first aspect, a length of the first minimum processing time and a length of the second minimum processing time are based at least in part on a minimum SCS of an SCS of the PDCCH, an SCS of the CLI resource, and an SCS of the PUSCH.

In a second aspect, alone or in combination with the first aspect, process 900 includes receiving an indication of the first minimum processing time and the second minimum processing time.

In a third aspect, alone or in combination with one or more of the first and second aspects, a length of the first minimum processing time is based at least in part on a UE capability for reporting CLI and a third minimum processing time between the end of the PDCCH communication and a time for transmitting a CSI report.

In a fourth aspect, alone or in combination with one or more of the first through third aspects, process 900 includes transmitting an indication of the UE capability for reporting CLI.

In a fifth aspect, alone or in combination with one or more of the first through fourth aspects, a length of the first minimum processing time is based at least in part on a configured time addition for reporting CLI and a third minimum processing time between the end of the PDCCH communication and a time for transmitting a CSI report.

In a sixth aspect, alone or in combination with one or more of the first through fifth aspects, the configured time addition is based at least in part on a receiving time difference between receiving CLI at the CLI resource and receiving a serving cell downlink signal.

In a seventh aspect, alone or in combination with one or more of the first through sixth aspects, the configured time addition is based at least in part on a time for switching between a receive FFT window for the CLI resource and a receive FFT window for a CSI reference signal.

In an eighth aspect, alone or in combination with one or more of the first through seventh aspects, process 900 includes receiving an indication of the configured time addition.

In a ninth aspect, alone or in combination with one or more of the first through eighth aspects, the configured time addition includes a first value for intra-cell CLI management and a second value for inter-cell CLI management.

In a tenth aspect, alone or in combination with one or more of the first through ninth aspects, a length of the second minimum processing time is based at least in part on a configured time addition for reporting CLI and a fourth minimum processing time between the end of the PDCCH communication and a time for transmitting a CSI report.

In an eleventh aspect, alone or in combination with one or more of the first through tenth aspects, the configured time addition includes a first value for intra-cell CLI management or a second value for inter-cell CLI management.

In a twelfth aspect, alone or in combination with one or more of the first through eleventh aspects, the first minimum processing time includes a first minimum processing time specific to an SRS-RSRP or a first minimum processing time specific to a CLI-RSSI, and the second minimum processing time includes a second minimum processing time specific to the SRS-RSRP or a second minimum processing time specific to the CLI-RSSI.

In a thirteenth aspect, alone or in combination with one or more of the first through twelfth aspects, the first minimum processing time is applicable to both a sounding reference SRS-RSRP and a CLI-RSSI, and the second minimum processing time is applicable to both the SRS-RSRP and the CLI-RSSI.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., base station 110, network entity 710) performs operations associated with timing for CLI reporting.

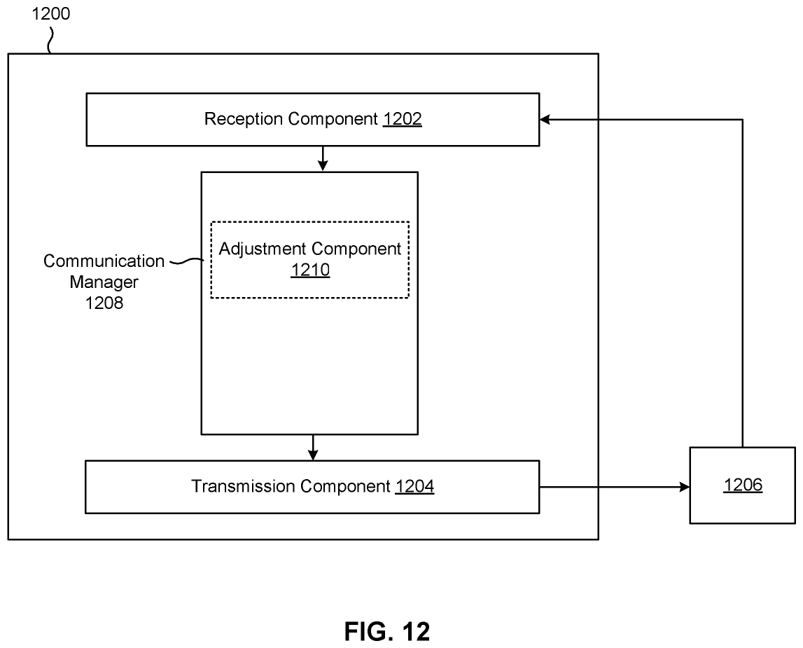

As shown in FIG. 10, in some aspects, process 1000 may include transmitting DCI in a PDCCH communication, the DCI indicating a CLI resource for measuring CLI (block 1010). For example, the network entity (e.g., using communication manager 1208 and/or transmission component 1204 depicted in FIG. 12) may transmit DCI in a PDCCH communication, the DCI indicating a CLI resource for measuring CLI, as described above.

As further shown in FIG. 10, in some aspects, process 1000 may include receiving a CLI report in a PUSCH communication after a first minimum processing time from an end of the PDCCH communication and after a second minimum processing time from an end of the CLI resource (block 1020). For example, the network entity (e.g., using communication manager 1208 and/or reception component 1202 depicted in FIG. 12) may receive a CLI report in a PUSCH communication after a first minimum processing time from an end of the PDCCH communication and after a second minimum processing time from an end of the CLI resource, as described above.

Process 1000 may include additional aspects, such as any single aspect or any combination of aspects described below and/or in connection with one or more other processes described elsewhere herein.

In a first aspect, process 1000 includes transmitting an indication of the first minimum processing time and the second minimum processing time.

In a second aspect, alone or in combination with the first aspect, process 1000 includes receiving an indication of a UE capability for reporting CLI, where a length of the first minimum processing time is based at least in part on the UE capability and a third minimum processing time between the end of the PDCCH communication and a time for transmitting a CSI report.

In a third aspect, alone or in combination with one or more of the first and second aspects, a length of the first minimum processing time is based at least in part on a configured time addition for reporting CLI and a third minimum processing time between the end of the PDCCH communication and a time for transmitting a CSI report.

In a fourth aspect, alone or in combination with one or more of the first through third aspects, the configured time addition is based at least in part on a receiving time difference between receiving CLI at the CLI resource and receiving a serving cell downlink signal.

In a fifth aspect, alone or in combination with one or more of the first through fourth aspects, the configured time addition is based at least in part on a time for switching between a receive FFT window for the CLI resource and a receive FFT window for a CSI reference signal.

In a sixth aspect, alone or in combination with one or more of the first through fifth aspects, process 1000 includes transmitting an indication of the configured time addition.

In a seventh aspect, alone or in combination with one or more of the first through sixth aspects, the configured time addition includes a first value for intra-cell CLI management or a second value for inter-cell CLI management.

In an eighth aspect, alone or in combination with one or more of the first through seventh aspects, a length of the second minimum processing time is based at least in part on a configured time addition for reporting CLI and a fourth minimum processing time between the end of the PDCCH communication and a time for transmitting a CSI report.

In a ninth aspect, alone or in combination with one or more of the first through eighth aspects, the first minimum processing time includes a first minimum processing time specific to a sounding reference SRS-RSRP or a first minimum processing time specific to a CLI-RSSI, and the second minimum processing time includes a second minimum processing time specific to the SRS-RSRP or a second minimum processing time specific to the CLI-RSSI.

In a tenth aspect, alone or in combination with one or more of the first through ninth aspects, the first minimum processing time is applicable to both a sounding reference SRS-RSRP and a CLI-RSSI, and the second minimum processing time is applicable to both the SRS-RSRP and the CLI-RSSI.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a UE (e.g., UE 120, UE 720), or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 1108 may control and/or otherwise manage one or more operations of the reception component 1102 and/or the transmission component 1104. In some aspects, the communication manager 1108 may include one or more antennas, a modem, a controller/processor, a memory, or a combination thereof, of the UE described in connection with FIG. 2. The communication manager 1108 may be, or be similar to, the communication manager 140 depicted in FIGS. 1 and 2. For example, in some aspects, the communication manager 1108 may be configured to perform one or more of the functions described as being performed by the communication manager 140. In some aspects, the communication manager 1108 may include the reception component 1102 and/or the transmission component 1104. The communication manager 1108 may include a measurement component 1110, among other examples.

In some aspects, the apparatus 1100 may be configured to perform one or more operations described herein in connection with FIGS. 1-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive DCI in a PDCCH communication. The measurement component 1110 may measure CLI at a CLI resource indicated by the DCI. The transmission component 1104 may transmit a CLI report in a PUSCH communication at a time that is based at least in part on a first minimum processing time between an end of the PDCCH communication and a beginning of the PUSCH communication and a second minimum processing time between an end of the CLI resource and the beginning of the PUSCH communication.

The reception component 1102 may receive an indication of the first minimum processing time and the second minimum processing time. The transmission component 1104 may transmit an indication of the UE capability for reporting CLI. The reception component 1102 may receive an indication of the configured time addition.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a network entity (e.g., base station 110, network entity 710), or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 1208. The communication manager 1208 may control and/or otherwise manage one or more operations of the reception component 1202 and/or the transmission component 1204. In some aspects, the communication manager 1208 may include one or more antennas, a modem, a controller/processor, a memory, or a combination thereof, of the network entity described in connection with FIG. 2. The communication manager 1208 may be, or be similar to, the communication manager 150 depicted in FIGS. 1 and 2. For example, in some aspects, the communication manager 1208 may be configured to perform one or more of the functions described as being performed by the communication manager 150. In some aspects, the communication manager 1208 may include the reception component 1202 and/or the transmission component 1204. The communication manager 1208 may include an adjustment component 1210, among other examples.

In some aspects, the apparatus 1200 may be configured to perform one or more operations described herein in connection with FIGS. 1-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the network entity described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the network entity described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the network entity described in connection with FIG. 2. In some aspects, the transmission component 1204 may be co-located with the reception component 1202 in a transceiver.

The transmission component 1204 may transmit DCI in a PDCCH communication, the DCI indicating a CLI resource for measuring CLI. The reception component 1202 may receive a CLI report in a PUSCH communication after a first minimum processing time from an end of the PDCCH communication and after a second minimum processing time from an end of the CLI resource. The adjustment component 1210 may adjust scheduling or a transmit power for communications based at least in part on the CLI report.

The transmission component 1204 may transmit an indication of the first minimum processing time and the second minimum processing time. The reception component 1202 may receive an indication of a UE capability for reporting CLI, where a length of the first minimum processing time is based at least in part on the UE capability and a third minimum processing time between the end of the PDCCH communication and a time for transmitting a CSI report. The transmission component 1204 may transmit an indication of the configured time addition.

The number and arrangement of components shown in FIG. 12 are provided as an example. In practice, there may be additional components, fewer components, different components, or differently arranged components than those shown in FIG. 12.

Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a user equipment (UE), comprising: receiving downlink control information (DCI) in a physical downlink control channel (PDCCH) communication; measuring cross-link interference (CLI) at a CLI resource indicated by the DCI; and transmitting a CLI report in a physical uplink shared channel (PUSCH) communication at a time that is based at least in part on a first minimum processing time between an end of the PDCCH communication and a beginning of the PUSCH communication and a second minimum processing time between an end of the CLI resource and the beginning of the PUSCH communication.

Aspect 2: The method of Aspect 1, wherein a length of the first minimum processing time and a length of the second minimum processing time are based at least in part on a minimum subcarrier spacing (SCS) of an SCS of the PDCCH, an SCS of the CLI resource, and an SCS of the PUSCH.

Aspect 3: The method of Aspect 1 or 2, further comprising receiving an indication of the first minimum processing time and the second minimum processing time.

Aspect 4: The method of any of Aspects 1-3, wherein a length of the first minimum processing time is based at least in part on a UE capability for reporting CLI and a third minimum processing time between the end of the PDCCH communication and a time for transmitting a channel state information (CSI) report.

Aspect 5: The method of Aspect 4, further comprising transmitting an indication of the UE capability for reporting CLI.

Aspect 6: The method of any of Aspects 1-5, wherein a length of the first minimum processing time is based at least in part on a configured time addition for reporting CLI and a third minimum processing time between the end of the PDCCH communication and a time for transmitting a channel state information (CSI) report.

Aspect 7: The method of Aspect 6, wherein the configured time addition is based at least in part on a receiving time difference between receiving CLI at the CLI resource and receiving a serving cell downlink signal.

Aspect 8: The method of Aspect 6 or 7, wherein the configured time addition is based at least in part on a time for switching between a receive fast Fourier transform (FFT) window for the CLI resource and a receive FFT window for a CSI reference signal.

Aspect 9: The method of any of Aspects 6-8, further comprising receiving an indication of the configured time addition.

Aspect 10: The method of any of Aspects 6-9, wherein the configured time addition includes a first value for intra-cell CLI management and a second value for inter-cell CLI management.

Aspect 11: The method of any of Aspects 1-10, wherein a length of the second minimum processing time is based at least in part on a configured time addition for reporting CLI and a fourth minimum processing time between the end of the PDCCH communication and a time for transmitting a channel state information (CSI) report.

Aspect 12: The method of Aspect 11, wherein the configured time addition includes a first value for intra-cell CLI management or a second value for inter-cell CLI management.

Aspect 13: The method of any of Aspects 1-12, wherein the first minimum processing time includes a first minimum processing time specific to a sounding reference signal reference signal received power (SRS-RSRP) or a first minimum processing time specific to a CLI received signal strength indicator (CLI-RSSI), and wherein the second minimum processing time includes a second minimum processing time specific to the SRS-RSRP or a second minimum processing time specific to the CLI-RSSI.

Aspect 14: The method of any of Aspects 1-13, wherein the first minimum processing time is applicable to both a sounding reference signal reference signal received power (SRS-RSRP) and a CLI received signal strength indicator (CLI-RSSI), and wherein the second minimum processing time is applicable to both the SRS-RSRP and the CLI-RSSI.

Aspect 15: A method of wireless communication performed by a network entity, comprising: transmitting downlink control information (DCI) in a physical downlink control channel (PDCCH) communication, the DCI indicating a cross-link interference (CLI) resource for measuring CLI; and receiving a CLI report in a physical uplink shared channel (PUSCH) communication after a first minimum processing time from an end of the PDCCH communication and after a second minimum processing time from an end of the CLI resource.

Aspect 16: The method of Aspect 15, further comprising transmitting an indication of the first minimum processing time and the second minimum processing time.

Aspect 17: The method of Aspect 15 or 16, further comprising receiving an indication of a UE capability for reporting CLI, wherein a length of the first minimum processing time is based at least in part on the UE capability and a third minimum processing time between the end of the PDCCH communication and a time for transmitting a channel state information (CSI) report.

Aspect 18: The method of any of Aspects 15-17, wherein a length of the first minimum processing time is based at least in part on a configured time addition for reporting CLI and a third minimum processing time between the end of the PDCCH communication and a time for transmitting a channel state information (CSI) report.

Aspect 19: The method of Aspect 18, wherein the configured time addition is based at least in part on a receiving time difference between receiving CLI at the CLI resource and receiving a serving cell downlink signal.

Aspect 20: The method of Aspect 18 or 19, wherein the configured time addition is based at least in part on a time for switching between a receive fast Fourier transform (FFT) window for the CLI resource and a receive FFT window for a CSI reference signal.

Aspect 21: The method of any of Aspects 18-20, further comprising transmitting an indication of the configured time addition.

Aspect 22: The method of any of Aspects 18-21, wherein the configured time addition includes a first value for intra-cell CLI management or a second value for inter-cell CLI management.

Aspect 23: The method of any of Aspects 15-21, wherein a length of the second minimum processing time is based at least in part on a configured time addition for reporting CLI and a fourth minimum processing time between the end of the PDCCH communication and a time for transmitting a channel state information (CSI) report.

Aspect 24: The method of any of Aspects 15-23, wherein the first minimum processing time includes a first minimum processing time specific to a sounding reference signal reference signal received power (SRS-RSRP) or a first minimum processing time specific to a CLI received signal strength indicator (CLI-RSSI), and wherein the second minimum processing time includes a second minimum processing time specific to the SRS-RSRP or a second minimum processing time specific to the CLI-RSSI.

Aspect 25: The method of any of Aspects 15-24, wherein the first minimum processing time is applicable to both a sounding reference signal reference signal received power (SRS-RSRP) and a CLI received signal strength indicator (CLI-RSSI), and wherein the second minimum processing time is applicable to both the SRS-RSRP and the CLI-RSSI.

Aspect 26: An apparatus for wireless communication at a device, comprising a processor; memory coupled with the processor; and instructions stored in the memory and executable by the processor to cause the apparatus to perform the method of one or more of Aspects 1-25.

Aspect 27: A device for wireless communication, comprising a memory and one or more processors coupled to the memory, the one or more processors configured to perform the method of one or more of Aspects 1-25.

Aspect 28: An apparatus for wireless communication, comprising at least one means for performing the method of one or more of Aspects 1-25.

Aspect 29: A non-transitory computer-readable medium storing code for wireless communication, the code comprising instructions executable by a processor to perform the method of one or more of Aspects 1-25.

Aspect 30: A non-transitory computer-readable medium storing a set of instructions for wireless communication, the set of instructions comprising one or more instructions that, when executed by one or more processors of a device, cause the device to perform the method of one or more of Aspects 1-25.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a +c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. An apparatus of a user equipment (UE) for wireless communication, comprising:
one or more memories; and
one or more processors, coupled to the one or more memories, individually or collectively configured to cause the UE to:
receive downlink control information (DCI) in a physical downlink control channel (PDCCH) communication;
measure cross-link interference (CLI) at a CLI resource indicated by the DCI; and
transmit a CLI report in a physical uplink shared channel (PUSCH) communication at a time that is based at least in part on a first minimum processing time between an end of the PDCCH communication and a beginning of the PUSCH communication and a second minimum processing time between an end of the CLI resource and the beginning of the PUSCH communication.

2. The apparatus of claim 1, wherein a length of the first minimum processing time and a length of the second minimum processing time are based at least in part on a minimum subcarrier spacing (SCS) of an SCS of the PDCCH, an SCS of the CLI resource, and an SCS of the PUSCH.

3. The apparatus of claim 1, wherein the one or more processors are individually or collectively configured to cause the UE to receive an indication of the first minimum processing time and the second minimum processing time.

4. The apparatus of claim 1, wherein a length of the first minimum processing time is based at least in part on a UE capability for reporting CLI and a third minimum processing time between the end of the PDCCH communication and a time for transmitting a channel state information (CSI) report.

5. The apparatus of claim 4, wherein the one or more processors are individually or collectively configured to cause the UE to transmit an indication of the UE capability for reporting CLI.

6. The apparatus of claim 1, wherein a length of the first minimum processing time is based at least in part on a configured time addition for reporting CLI and a third minimum processing time between the end of the PDCCH communication and a time for transmitting a channel state information (CSI) report.

7. The apparatus of claim 6, wherein the configured time addition is based at least in part on a receiving time difference between receiving CLI at the CLI resource and receiving a serving cell downlink signal.

8. The apparatus of claim 6, wherein the configured time addition is based at least in part on a time for switching between a receive fast Fourier transform (FFT) window for the CLI resource and a receive FFT window for a CSI reference signal.

9. The apparatus of claim 6, wherein the one or more processors are individually or collectively configured to cause the UE to receive an indication of the configured time addition.

10. The apparatus of claim 6, wherein the configured time addition includes a first value for intra-cell CLI management and a second value for inter-cell CLI management.

11. The apparatus of claim 1, wherein a length of the second minimum processing time is based at least in part on a configured time addition for reporting CLI and a fourth minimum processing time between the end of the PDCCH communication and a time for transmitting a channel state information (CSI) report.

12. The apparatus of claim 11, wherein the configured time addition includes a first value for intra-cell CLI management or a second value for inter-cell CLI management.

13. The apparatus of claim 1, wherein the first minimum processing time includes a first minimum processing time specific to a sounding reference signal reference signal received power (SRS-RSRP) or a first minimum processing time specific to a CLI received signal strength indicator (CLI-RSSI), and wherein the second minimum processing time includes a second minimum processing time specific to the SRS-RSRP or a second minimum processing time specific to the CLI-RSSI.

14. The apparatus of claim 1, wherein the first minimum processing time is applicable to both a sounding reference signal reference signal received power (SRS-RSRP) and a CLI received signal strength indicator (CLI-RSSI), and wherein the second minimum processing time is applicable to both the SRS-RSRP and the CLI-RSSI.

15. An apparatus of a network entity for wireless communication, comprising:
one or more memories; and
one or more processors, coupled to the one or more memories, individually or collectively configured to cause the network entity to:
transmit downlink control information (DCI) in a physical downlink control channel (PDCCH) communication, the DCI indicating a cross-link interference (CLI) resource for measuring CLI; and
receive a CLI report in a physical uplink shared channel (PUSCH) communication after a first minimum processing time from an end of the PDCCH communication and after a second minimum processing time from an end of the CLI resource.

16. The apparatus of claim 15, wherein the one or more processors are individually or collectively configured to cause the network entity to transmit an indication of the first minimum processing time and the second minimum processing time.

17. The apparatus of claim 15, wherein the one or more processors are individually or collectively configured to cause the network entity to receive an indication of a UE capability for reporting CLI, wherein a length of the first minimum processing time is based at least in part on the UE capability and a third minimum processing time between the end of the PDCCH communication and a time for transmitting a channel state information (CSI) report.

18. The apparatus of claim 15, wherein a length of the first minimum processing time is based at least in part on a configured time addition for reporting CLI and a third minimum processing time between the end of the PDCCH communication and a time for transmitting a channel state information (CSI) report.

19. The apparatus of claim 18, wherein the configured time addition is based at least in part on a receiving time difference between receiving CLI at the CLI resource and receiving a serving cell downlink signal.

20. The apparatus of claim 18, wherein the configured time addition is based at least in part on a time for switching between a receive fast Fourier transform (FFT) window for the CLI resource and a receive FFT window for a CSI reference signal.

21-30. (canceled)
